(19) United States
(12) Patent Application Publication
(10) Pub. No.: US 2024/0114856 A1
(43) Pub. Date: Apr. 11, 2024

(54) Seed Germination and Plant Development Article with Phosphor

(71) Applicant: JUST GREENS, LLC, Newark, NJ (US)

(72) Inventor: Roger Buelow, Pepper Pike, OH (US)

(73) Assignee: AeroFarms, Inc., Newark, NJ (US)

(21) Appl. No.: 18/270,413

(22) PCT Filed: Dec. 30, 2021
(86) PCT No.: PCT/US2021/065631

§ 371 Date: Jun. 29, 2023

Related U.S. Application Data
(60) Provisional application No. 63/132,140, filed on Dec. 30, 2020.

(51) Int. Cl. A01G 24/10; A01G 7/04

(52) U.S. Cl. CPC A01G 24/10; A01G 7/045; A01G 24/44

(57) ABSTRACT

An article that supports germinating seeds and growing plants is provided and disclosed. The article includes a substrate with openings therethrough for developing plants. The substrate includes a phosphor containing layer on the closed substrate surfaces and optionally a reflective layer below the phosphor containing layer on the closed surfaces. The substrate with openings and phosphor containing layer on closed surfaces of the substrate can be disposed over a growth medium. The article having the phosphor containing layer is configured to convert at least a portion of incident plant growth light into longer wavelength red spectrum containing light, and redirect the red light to the developing plants.

### CROSS-REFERENCE TO RELATED APPLICATIONS

The present application claims priority benefit to provisional patent application entitled “Seed Germination and Plant Development Article with Phosphor” which was filed on Dec. 30, 2020, and assigned U.S. Ser. No. 63/132,140. The content of the foregoing provisional patent application is incorporated herein by reference.

### TECHNICAL FIELD

This disclosure relates generally to articles that can be used in plant growth chambers to improve the utilization of light for growing the plants.

### BACKGROUND

Aeroponic farming involves spraying a liquid nutrient solution on the roots of developing plants. The roots of these plants are generally bare and suspended in a growth chamber where the nutrients are sprayed. In some versions of aeroponic farming, seeds are deposited on the top surface of a cloth (e.g., a growth media) that can be supported by a frame. The seeds are germinated, and then cloth on the frame is placed in the growth chamber. In the growth chamber, the upper side of the cloth is subjected to light of the proper wavelength and intensity to promote growth in developing the plants, and the underside of the cloth and the developing root mass receives the nutrient solution. The plants resulting from the seeds are harvested at a desired stage of growth. The growth chambers can be stacked on each other and/or located side-by-side to save space within a facility and to permit sharing of the subsystems, which provide the nutrient solution, temperature, humidity, and carbon dioxide to the growth chambers.

FIG. 1 is a diagrammatic view of a traditional aeroponic system 10 (herein after “system 10”). System 10 includes a growth media 12 upon which seeds are placed, a light source 14 positioned above the growth media 12 to subject the upper side of the growth media 12 to light. Nutrients as a spray 13 can be delivered on the roots 15 of the plants in support or container 17 with nozzles 16 to promote the growth of plants 18. Selecting the proper wavelength and/or intensity of light delivered to the cloth during germination and subsequent plant growth ensures growth in the developing plants. If blue and/or ultraviolet (UV) light-emitting diodes (LEDs) are used as the light source 14, energy loss occurs when converting the blue or UV light into white light. Light rays 20 from the light source 14 can strike the growth media 12 and/or objects 22 surrounding the plants 18, and scatter away from the plants 18, thereby resulting in loss of light away from developing plants 18.

If blue and/or red LEDs are used for developing plants 18, red light can be absorbed at early stages by the developing plants 18, while blue light can be scattered from leaves of the plants 18, the growth media 12, and/or materials or objects 22 between the plants 18 or in proximity to the plants. The illumination of plants 18 in traditional systems 10 can therefore result in scattering of light that creates a loss in the amount of light reaching the plants 18. Such light loss can decrease the efficiency of plant growth, and the overall efficiency of the system 10.

Thus, a need exists for improved growth media and systems comprising the growth media that can be used in aeroponic and hydroponic farming which improves illumination of seeds and developing plants.

### SUMMARY

Embodiments of the present disclosure provide an article for supporting seed germination and plant growth. The article can be positioned below leaves of a developing plant and the article can include a layer of material on a top surface that can absorb short wavelength light incident on the article and reemit light with longer wavelengths to the leaves of the developing plant (e.g., a light remitting or phosphor containing layer). In some embodiments of the disclosure the article can include a layer of phosphor containing material on a top surface of a substrate, the phosphor containing material can absorb short wavelength light, e.g. blue spectrum wavelengths between 400 nm and 525 nm, and reemit the light at longer wavelengths, e.g. red spectrum wavelengths between 620 nm and 750 nm, to germinated seedlings and plants with shoots located above the article.

The article can optionally include a reflective layer positioned below the light remitting layer or phosphor layer. An optional reflective layer positioned below the light remitting or phosphor layer of the article can reflect shorter wavelength light that passes through the phosphor layer back up towards the phosphor layer for reemission and the reflective layer can reflect any longer wavelength light back toward the plant leaves. The article can further include a growth medium that can be positioned below the light remitting or phosphor layer. Shoots including leaves and stems of developing plants can develop above the phosphor layer. The light remitting or phosphor containing layer can include phosphor and/or phosphor particles that can convert blue light into red light, and redirect the red light to the bottom surface of leaves of the developing plants. The redirected red light assists in plant growth and developments, resulting in a more efficient growth process and improved utilization of light incident on the developing plants.

The article that includes the phosphor containing layer on the substrate can have one or more openings therethrough the substrate for developing plants to grow through, and the article can be positioned atop of a plant growth medium. The article with the phosphor containing layer and one or more openings therethrough can optionally include a reflective layer. The phosphor containing layer and the optional reflective layer can coat closed, unopened, portions of the substrate. The article can cover spaces between developing plants positioned in a plant growth medium, for example but not limited to plants growing in a plant growth medium in separated net pots or other containers.

Some embodiments of the present disclosure can include articles that can support germinating seeds and growing plants. Some other embodiments of the disclosure can include articles that can be positioned between developing plants, and/or the articles that can be positioned atop of a growth medium supporting developing plants. The articles can include a soilless growth medium disposed on a support layer. The soilless growth medium is capable of accommodating one or more seeds and supporting seed germination and penetration of roots from developing plants therethrough. The article includes a phosphor containing layer and optionally a reflective layer disposed below the phosphor containing layer. The phosphor layer and optional reflective layer can include a plurality of openings extending through a thickness of the phosphor layer and optionally the reflective layer, each opening of the plurality of openings capable of accommodating passage therethrough of developing plants. The article includes at least a phosphor layer, or a composite with phosphor particles, and optionally a reflective layer below the phosphor containing layer. The article can be configured to convert a portion or all of short wavelength blue spectrum light incident on the phosphor containing layer into longer wavelength red spectrum light, and redirect the remitted red spectrum light to the developing plants.

In some embodiments of the article of the disclosure, the phosphor containing layer can be coated atop a corrugated substrate. In some embodiments, the phosphor containing layer can include phosphor particles that can be mulched phosphor chips. Optionally a reflective layer can be positioned below the phosphor containing layer. In some embodiments the reflective layer can be positioned on the bottom surface of the corrugated substrate. In some embodiments of the disclosure phosphor containing layer atop the corrugated substrate can be disposed substantially at a growth plane of the developing plants. The incident light provided to developing plants can include blue spectrum light, and the phosphor layer or the composite with phosphor particles can convert the blue spectrum light into red spectrum light. The phosphor containing layer can redirect the red spectrum light to a bottom surface of leaves of the developing plants. In some embodiments, the phosphor containing layer can be configured to redirect a portion of the incident light down to the one or more seeds contacting the growth medium to promote germination. In some embodiments the article including the phosphor layer can be separable from, positioned on top of, and can be structurally distinct from an underlying growth medium or a soilless growth medium. A bottom support can be positioned below the soilless growth medium, the support can include a plurality of holes to accommodate penetration of the roots from the developing plants through the bottom support.

In some embodiments the phosphor layer can be atop a corrugated substrate, the corrugated substrate can have a reflective surface, and the corrugated substrate can include a plurality of openings extending through a thickness of the phosphor layer. Each opening of the plurality of openings capable of accommodating passage therethrough of developing plants. In some other embodiments the phosphor layer and an optional reflective layer can be positioned atop the corrugated substrate, and the corrugated substrate can include a plurality of openings extending through a thickness of the phosphor layer and optionally the reflective layer. In some embodiments each opening of the plurality of openings can accommodate passage therethrough of developing plants or a flow of air.

Embodiments of the present disclosure can include methods of seed germination and plant growth. The method can include supporting one or more seeds, rhizomes, or root cuttings in or atop a growth medium. The growth medium can be a soilless growth medium. The growth medium can be contained in one or more net pots, bags, or the soilless growth medium can be disposed on a bottom support layer. The growth medium supports seed germination and penetration of roots from developing plants through the growth medium. The method can include red shifting or converting shorter wavelength incident light on a phosphor containing layer atop a substrate into longer wavelength light, e.g., red light, with at least a phosphor layer or a composite layer containing phosphor particles, and redirecting the red light, or red shifted light remitted by the phosphor containing layer back to the developing plants. A reflective layer can be positioned below the phosphor containing layer atop the substrate. The phosphor containing layer atop the substrate, and optional reflective layer, can include a plurality of openings and can be positioned above a growth medium. Each opening of the plurality of openings is capable of accommodating passage therethrough of the developing plants. In some embodiments, the substrate can be a corrugated substrate.

The phosphor containing layer atop the substrate and the optional underlying reflective layer of the article can be disposed below the first leaves or shoot system of developing plants in some embodiments of the methods of the disclosure. In other embodiments of the methods of the disclosure, the article can be substantially above or substantially level with a growth plane of the developing plants. The incident light used to grow the plants in embodiments of methods the disclosure can include light in a blue region of the spectrum, and the method can include converting some or all of this shorter wavelength blue spectrum light with the phosphor layer or the composite with phosphor particles into longer wavelength light in a red region of the spectrum, e.g. red light. In some embodiments of the methods of the disclosure the incident light can be white light. In other embodiments of the methods of the disclosure the incident light can be a mixture including blue light and red light. The method can include redirecting the red light reemitted by the phosphor containing layer to a bottom surface of leaves or other portions of the developing plants. The method can include redirecting a portion of the incident light with the phosphor containing layer down to the one or more seeds to promote germination. The phosphor containing layer atop a substrate and optional reflective layer is separable from, positioned on top of, and is structurally distinct from an underlying growth medium or underlying soilless growth medium. In some embodiments, the phosphor particles can be mulched phosphor chips.

In accordance with embodiments of the present disclosure, seed germination and plant growth systems can be provided. The systems can include a growth chamber, a light source that can illuminate developing plants disposed within the growth chamber, and an article disposed within the growth chamber and under the light source. The article can have a phosphor containing layer atop a substrate, the phosphor containing layer can wavelength shift light in a blue region of the spectrum into light in a red region of the spectrum.

The article disposed within the chamber can optionally include a reflective layer below the phosphor containing layer. The phosphor containing layer and optional reflective layer can include a plurality of openings extending through a thickness of the phosphor layer and optional reflective layer, each opening of the plurality of openings capable of accommodating passage therethrough of the developing plants in the growth chamber. The article can cover all (or substantially all) or a portion of the space between developing plants in the growth chamber. In some embodiments of the disclosure the article can be positioned atop of a growth medium, such as a soilless growth medium, in the growth chamber, and the growth medium can be disposed on a bottom support layer in the growth chamber. In other embodiments of the growth chamber, the growth medium can be positioned in separate containers (e.g. net pots, bags with openings) and the containers positioned and aligned with openings of the article substrate including the phosphor coating. The openings through the phosphor containing layer, through the substrate, and through the optional reflective layer are capable of accommodating passage therethrough of the developing plants. The growth medium is capable of accommodating one or more seeds, rhizomes, root cuttings and the like, and supporting seed germination and penetration of roots from developing plants therethrough.

The article including a phosphor containing layer on a substrate and an optional reflective layer below the phosphor containing layer can redirect short wavelength light that may have initially passed through the phosphor layer back into the phosphor layer where it can be further red shifted and directed to the developing plants. The substrate including the phosphor containing layer can be a flexible film or a semi-rigid or rigid sheet. The substrate including the phosphor layer can be transparent; the optional underlying reflective layer can be below the phosphor layer and atop the substrate or the underlying reflective layer can be on a lower surface below the top surface of the substrate. The article can be disposed over all, or disposed only over portions of the growth medium. The wavelength shifting layer includes at least a phosphor layer or a composite with phosphor particles configured to convert light incident on the reflective layer from the light source into red light, and redirect the red light to the developing plants.

The system can include a nutrition source disposed below the article including the phosphor containing layer. The nutrition source of the system can include a plurality of nozzles configured to direct a spray or mist of nutrient solution to the roots of the developing plants. The nutrition source can be a bath of nutrient solution configured to contact the plant roots. The nutrient source can be a thin film of nutrient solution configured to contact the plant roots or an ebb and flow of nutrient solution configured to contact the plant roots. The phosphor containing layer can be disposed substantially at a growth plane of the developing plants. The phosphor layer or the composite with phosphor particles can redirect the red light to a bottom surface of leaves of the developing plants. The light remitting or phosphor containing layer including the phosphor and/or phosphor particles that can convert blue light into red light, can redirect the red light to the of leaves and shoot system surfaces of the developing plants in a variety of growing environments including indoor farming growth chambers, greenhouses, and field grown plants.

Embodiments of articles of the disclosure including a phosphor containing layer atop a substrate, an optional reflective layer below the phosphor layer, and including a plurality of openings extending through a thickness of these can be used in other applications within growth chambers where redirection and wavelength shifting of incident grow light back to plant surfaces can improve light use by the plants and reduce costs for growing. The openings formed through the phosphor coating and substrate can facilitate positioning the article with respect to the growth chamber and providing light shifted to longer wavelengths light from the incident light to surfaces of the plant such as leaves and stems for plant growth and development. In some embodiments where the substrate is flexible, the substrate may be bent, wrapped, or otherwise configured to redirect, and in some embodiments focus, light shifted to longer wavelengths back to surfaces of the plants. For example, the article can be made convex below plant leaves to direct light from the edges of a grow tray back toward the center of the tray. Similarly, the article may be positioned and its profile configured along sides of a growth chamber to redirect, and in some embodiments focus, wavelength shifted light back to surfaces of the plants.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the seed germination and plant development article, reference is made to the accompanying figures, wherein:

FIG. 1 is a diagrammatic view of a traditional aeroponic system;

FIG. 2 is a diagrammatic view of layers of an embodiment of a seed germination and plant development media of the present disclosure;

FIG. 3 is a detailed view of an embodiment of a seed germination and plant development system of the present disclosure;

FIG. 4 is a detailed view of an embodiment of a seed germination and plant development media of the present disclosure; and

FIG. 5 is a diagrammatic view of light incident on developing plants and a phosphor containing layer atop a substrate positioned above a seed germination and plant development media of the present disclosure;

FIG. 6 is a diagrammatic, cross-sectional view of light incident on developing plants and a phosphor containing layer atop a substrate with optional reflective layer below the phosphor containing layer;

FIG. 7 is a cross-sectional image of an embodiment of a substrate that can have a layer of phosphor containing material atop an upper surface;

FIGS. 8A-C illustrate embodiments of plant development systems and articles positioned in relation to the plant development system and growth chambers that can redirect at least a portion of plant growth light provided by the plant development system or growth chamber as longer wavelength shifted light onto surfaces of developing plants in the growth chamber;

FIGS. 9A-D illustrate a top view of articles in embodiments of the description that can redirect at least a portion of plant growth light from a plant growth system or growth chamber as longer wavelength shifted light onto surfaces of developing plants in the growth chamber.

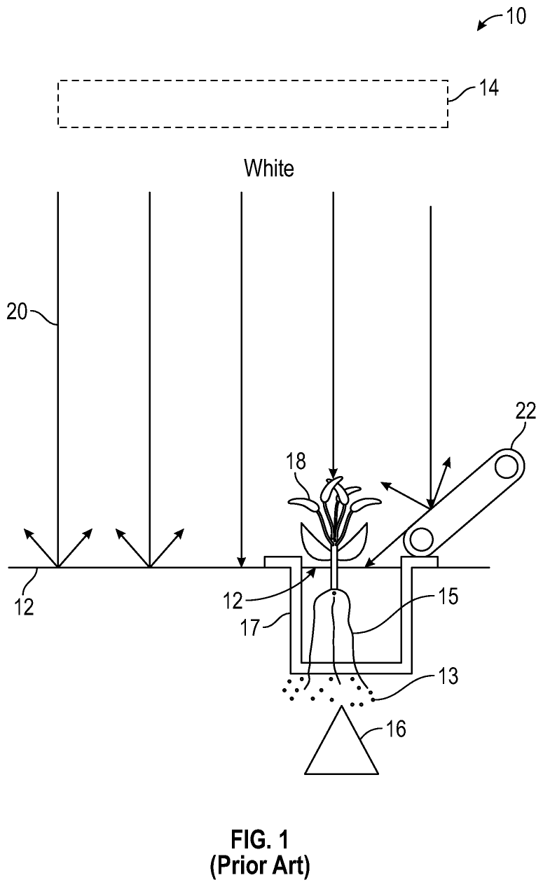

### DETAILED DESCRIPTION

In the following description, it is understood that terms such as “top,” “bottom,” “outward,” “inward,” and the like are words of convenience and are not to be construed as limiting terms. Reference will now be made in detail to embodiments of the disclosure, which are illustrated in the accompanying figures and examples. Referring to the drawings in general, it will be understood that the illustrations are for the purpose of describing particular embodiments of the disclosure and are not intended to limit the same.

Whenever a particular embodiment of the disclosure is said to comprise or consist of at least one element of a group and combinations thereof, it is understood that the embodiment may comprise or consist of any of the elements of the group, either individually or in combination with any of the other elements of that group.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

In embodiments of the disclosure, the term “developing plant(s)” can refer to one or more germinating seeds, one or more seedlings with or without true leaves, one or more growing plants, or any combination of these that are on a generally top surface of the growth medium.

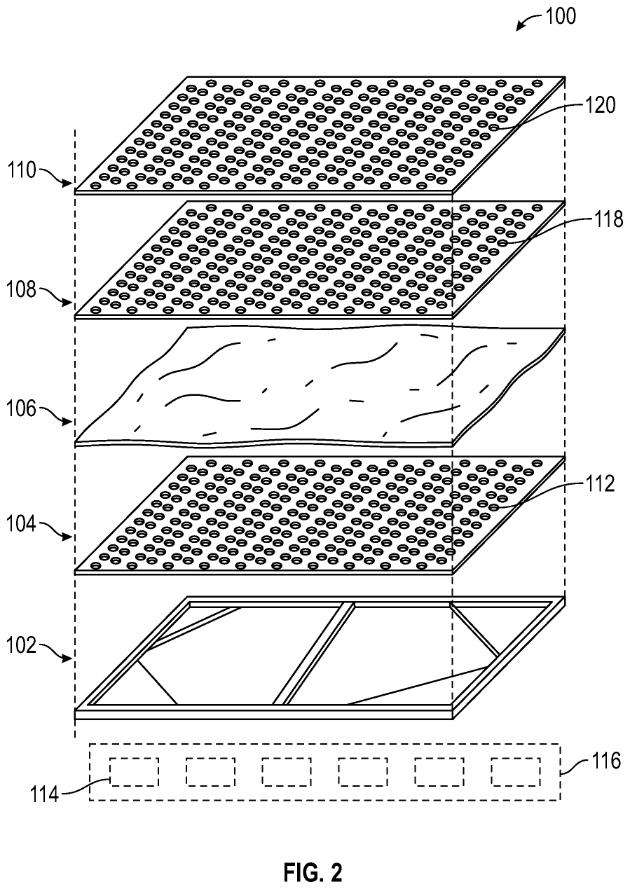

FIG. 2 is a diagrammatic view of a seed germination and plant development article 100 (hereinafter “article 100”) that can be used with hydroponic and aeroponic growth chambers and systems. The article 100 can be placed over sprayers in aeroponic chambers that deliver nutrients to the plant roots or the article 100 can be placed over containers that provide nutrient solution to plant roots. The article 100 can be substantially similar to the article 100 discussed in International Patent Publication No. WO 2020/005319, which is incorporated herein by reference in its entirety. The article 100 can include several layers. From bottom to top in FIG. 2, the first layer 102 is an optional frame that can be used to support one or more overlying layers (104-110, or more). Layer 104 can be an optional bottom support layer that has one or more, or a plurality, of openings 112 formed therein and extending therethrough. The bottom support layer 104 can accommodate one or more root masses from the overlying plants. The openings 112 in the optional bottom support layer 104 can allow mist or fog from the nozzles or sprayers 114 of a nutrition source 116 that may be located below the support to reach the growth medium 106. The unopened portions of the bottom support layer 104 can block all or a portion of light incident on the flat from reaching surfaces below the bottom support layer 104. These surfaces below the bottom support layer 104 can include drip pans and nozzles (e.g., sprayers 114) or nutrient containers (not shown).

The article 100 can further include a soilless growth medium 106 (e.g., layer 106) that can be positioned atop the bottom support layer 104 and that is freely separable from and not fixed to the bottom support layer 104. The soilless growth medium 106 supports seed germination, penetration of roots from developing plants through the medium 106, and in aeroponic systems can also prevent the direct passage of nutrient mist or fog droplets through the medium 106. The article 100 includes a light barrier layer 108 positioned over the medium 106. The light barrier layer 108 has a plurality of openings 118 and has un-opened portions (e.g., portions surrounding the openings 118). The un-opened or solid portions of the light barrier layer 108 have a light transmittance, measured by intensity, that is less than, and in some embodiments at least 50% less than, the amount of the light transmittance through any opening 118 in the light barrier layer 108. The light barrier layer 108 is freely separable from and positioned atop the soilless growth medium 106. The openings in 118 can be between about 20% and about 70% of the surface area of the light barrier layer 108.

An optional upper layer 110 can be used in the article 100 that is freely separable from the light barrier layer 108, has a plurality of openings 120, and can be positioned over the light barrier layer 108. The openings 120 in the upper layer 110 overlap a portion or all of the area of the openings 118 in the light barrier layer 108, the overlap of the openings 118, 120 between the two layers 108, 110 being sufficient for light to reach the soilless growth medium 106 and/or germinating seeds, or to develop plants on the growth medium 106 through the openings 118, 120. The light barrier layer 108 and the upper layer 110 can be separated from each other and a cutter passed between them to sever the stems and harvest developed plants. In some embodiments one or more of the light barrier layer 108, the upper layer 110, or the light barrier layer 108 and upper layer 110 can include a fluorescent material or a phosphor material. In some embodiments, one or more of the layers 102-110 can be combined into a single layer.

Each of the layers 108-110 in FIG. 2 can be in the form of a sheet, plane or film. In some embodiments, one or more of the layers 108-110 can be fabricated from metals, polymers, ceramics, composite materials, and any combination thereof. In some embodiments, the light barrier layer 108 can include a fluorescent material or phosphor that converts a portion or all of the light that is incident on surfaces of the light barrier layer 108, for example surfaces that are not those of the plants, to a longer wavelength light of which a portion can be directed to the germinating seeds and/or developing plants on the growth medium. In some embodiments, the optional upper layer 110 can include a fluorescent material or a phosphor material that converts a portion or all of the light that is incident on surfaces of the upper layer 110, for example surfaces that are not those of the plants, to a longer wavelength light of which a portion can be directed to the germinating seeds and/or developing plants on the growth medium. In other embodiments, the upper layer 110 can be transparent to light and transmits a portion of the incident light to the light barrier layer 108 which can include a fluorescent material and/or a phosphor layer.

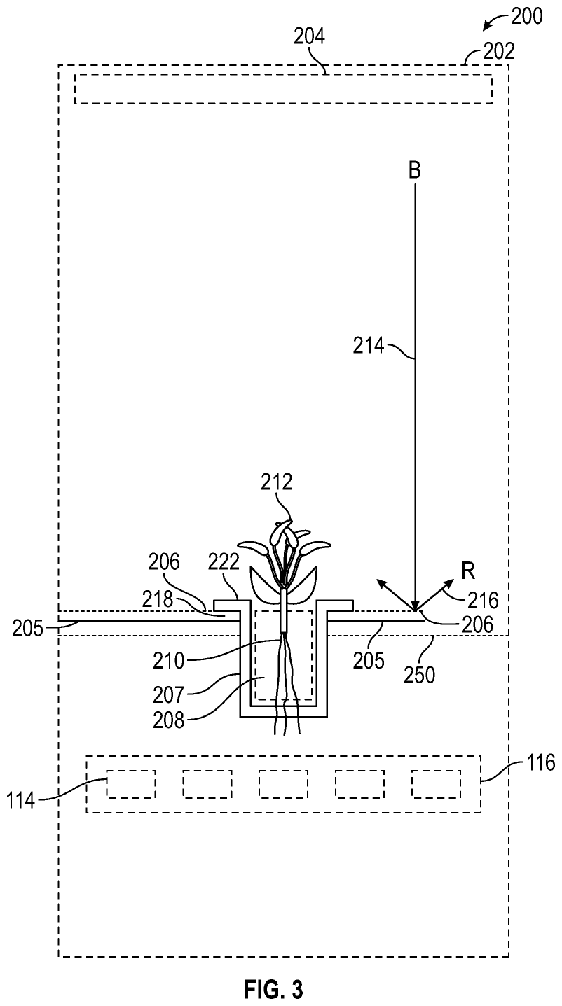

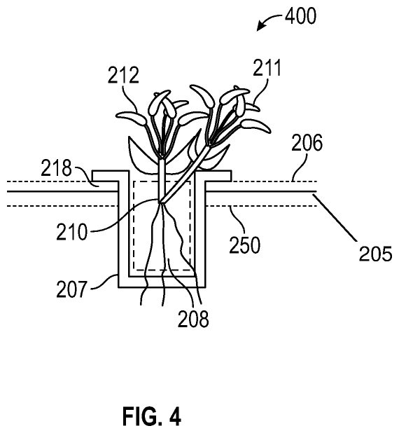

The phosphor containing material or layer 206 (represented as a top dashed line) can include a plurality of openings 218 to allow for the positioning of containers 207 and passage of growing plants 212 therethrough (see, e.g., FIGS. 3 and 4). The phosphor containing layer 206 can include a phosphor material therein, a phosphor material embedded throughout the substrate material 205, or both. In embodiments having the phosphor material embedded into the substrate material 205, the phosphor can be in the form of mulched chips or fine micron or sub-micron sized phosphor particles. In both instances, the phosphor material forms substantially all of the top surface of the layer 206. The phosphor containing layer 206, and optionally the reflective layer 250, can cover or coat closed portions, e.g., regions without openings such as 218, of the top surface and bottom surface of the substrate 205.

The phosphor containing material 206 can be a heavy or thick layer of phosphor containing material that can be several microns thick. The phosphor layer 206 can be non-transparent. In some embodiments the phosphor material containing 206 can be reflective-phosphortech and radiantFlex (YAG based).

The phosphor containing material or layer 206 can be positioned at the growth plane (point of protrusion of shoot from the growth media or an average point of protrusion of the shoots from the growth media) of the plants, with roots below the phosphor containing layer 206 and substantially all of the greens of the plant (e.g., stem and leaves) at or above the phosphor containing layer 206. The phosphor(s) can convert unused or scattered blue spectrum portion 214 of light 204 into red spectrum light 216 which can be provided or reemitted to the bottom of the leaves of the plant. The phosphor(s) can convert unused or scattered blue spectrum containing light, for example white light or magenta light (e.g. as produced from red and blue light emitting diodes) from which the blue spectrum portion 214 of the light into red spectrum light 216 by the phosphor containing material 206. The red spectrum light from the phosphor material can be provided to the surfaces of the plants such as the bottom of the leaves of the plant 212.

Light can therefore be redirected from the phosphor containing layer 206 and optional reflective layer 250 back to the leaves to promote growth and spread 211 of the leaves, and can further be redirected down to the seeds to promote germination. LED lights at the growth plane are generally not a viable solution for providing photons to the bottom of leaves of the plant, because the added LEDs would generate undesired heat to the plant and add to the overall capital cost and electric energy used to operate the system. Higher amounts of red light provided by the phosphor containing layer 206, and optionally the reflective layer 250, during the early part of the growth cycle can help with spreading of the plants. Red light can increase the growth and spread of the plants 212. This increased growth and spreading can be illustrated schematically in FIG. 4 at 211, where for example after a period of time later compared to the plant 212 in FIG. 3, the added red light results in greater growth, e.g. a new shoot 211, and an increase in the overall spread of the plant 212. Wavelength shifting unused or scattered light in a growth chamber can increase utilization of light from sources, result in improved utilization of electric energy, and promote a canopy which inhibits algal growth, thereby increasing overall yield on the growth media. By incorporating the phosphor containing layer atop the substrate, and optionally the reflective layer below the phosphor containing layer, yield improvement, uniformity of plant grow improvement, and overall cost reductions in operating the associated system, can be achieved. During experimentation with the system, the cost of goods and services (COGS) improvement was about 3-10% or less. The COGS yield improvement was found to be about 25-35%. The uniformity improvement was about 5%.

With reference to FIG. 3, a diagrammatic view of an embodiment of a seed germination and plant development system 200 (hereinafter “system 200”) that incorporates a growth media 208 within container 207 is provided. The container 207 can have a rim 222 that can be supported by edges of an opening 218 in the phosphor containing layer 206 (represented by top dashed line) and substrate 205 (represented by solid line). The phosphor containing layer 206 can be atop substrate 205. In some embodiments, the bottom surface of the substrate 205 can be silvered or have a reflective layer 250 deposited thereon. The reflective layer 250 can reflect light that passes through the phosphor containing layer 206 and the substrate 205 back towards the phosphor material or layer 206 and to the plants 212. The plants 212 have roots 210 that can extend through the grow medium 208 and through openings (not shown) in the container 207. The roots 210 that extend beyond the container 207 and grow media 208 can be contacted with nutrients from the nutrient source 116. The system 200 can further include a growth chamber 202, a light source 204 disposed over the media 208 and phosphor containing layer 206, and a nutrition source 116 with nozzles or sprayers 114 disposed below the substrate 205, the media 208, and the container 207. The growth chamber 202 can encompass the plants including the plant canopy or plant envelope as well as the grow media supporting the developing plants. The growth chamber 202 may include within the chamber a single or shared nutrient supply, dedicated or shared lighting, structural members or framing for one or more growth chambers, and dedicated or shared nutrient supply and drainage. Air flow can be provided to the growth chamber 202 and to the developing plants 212.

In one embodiment illustrated by FIG. 3, the material portion 206 can be a phosphor containing material or layer, 205 can be a substrate material or layer that can be integral or non-integral with layer 206 or 250, and 250 can be a reflective material. In some embodiments the reflective material 250 can be a corrugated polymer (e.g. substrate 700), a monolithic material such as a polymer, ceramic, or metal, or a film of the above including woven, cast, or air-laid materials. In some embodiments the substrate layer is optional and for example the phosphor containing layer is adjacent to the reflective layer and formed as a flexible sheet. In other embodiments the reflective material 250 is optional and the substrate 205 surface adjacent to the phosphor material 206 can be reflective or partially reflective to the incident light and/or wavelength shifted light from the phosphor material 206. For example, the partially reflective substrate material 205 adjacent to the phosphor layer or the reflective layer 250 can have a reflectivity of less than 90 percent for the incident light and/or the wavelength shifted light from the phosphor layer. A non-limiting example of a substrate 205 surface adjacent to the phosphor layer 206 can be a reflective surface such as the white surface of a corrugated polymer or a polymer composite. In some embodiments a reflective material 250 can be applied atop the surface of the substrate 205. In some embodiments the substrate 205 can be transparent.

In some embodiments the reflective material 250 may be absent and the substrate 205 outer surface, which can be reflective or partially reflective to the incident light and/or wavelength shifted light from the phosphor material, can be adjacent to the phosphor material 206. For example, the substrate material 205 top surface can be reflective or partially reflective and positioned adjacent to the phosphor layer 206. In embodiments of the disclosure, the reflective material or reflective surface of a substrate can reflect the incident light and/or the wavelength shifted light from the phosphor layer. In some embodiments of the disclosure, the reflective material or reflective surface of a substrate can have a reflectivity of less than 90 percent for the incident light and/or the wavelength shifted light from the phosphor layer.

In some embodiments, for example as illustrated in FIG. 3, a portion of the article consisting of materials 206, 205, and optionally reflective material 250 can be placed inside the container 207, or optionally atop the lip or rim 222, and over the plant growth media 208. The article can have an opening that accommodates the shoot portion of the plant 212.

FIG. 4 is a detailed cross-sectional view of an embodiment of a system 400 of the disclosure that includes a substrate 205, container 207 with grow media 208, and plant 212 from FIG. 3 after being subject to red light redirected by the phosphor layer to surfaces of the plant 212. FIG. 4 illustrates another shoot 211 was formed from plant 212 as a result of the red light. Plants 211 and 212 are shown with roots 210. The containers 207 can have lips or rims 222 that can overlap openings 218 in the substrate 205, openings in the phosphor containing layer 206, and openings in the optional reflective layer 250. The phosphor containing layer 206 can be deposited on the top surface of the substrate 205. Similar to the system 200 in FIG. 3, the system 400 can be placed in a growth chamber 202 and provided with a light source 204 disposed over the media 208 and phosphor containing layer 206 atop the substrate 205. As in FIG. 3, a nutrition source 116 with nozzles or sprayers 114 can be disposed below the media 208, containers 207, and substrate 205.

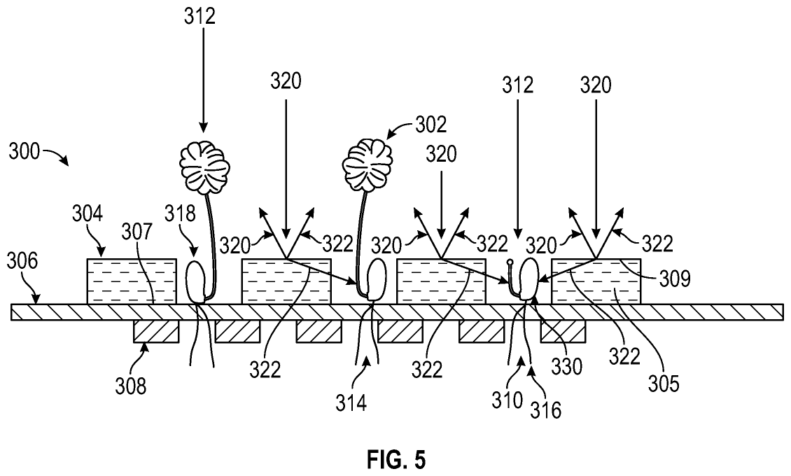

FIG. 5 illustrates light incident on germinating seeds 330 and developing plants 302 positioned in openings of an article 300 that includes a substrate 305 having a first surface or top surface 309 and a second surface or bottom surface 307. Article 300 can be positioned on the top surface of a plant growth medium 306. In FIG. 5, openings 318 can be similar to the openings such as 112, 118, 120 formed in the layers 104, 108, 110 in FIG. 2. A light source can provide light of blue spectrum containing light 312 and 320 directed at the phosphor layer 304 or plants 302. Because the phosphor in the phosphor containing layer 304 is disposed below the greens (e.g., leaves) of the plants 302, the red spectrum light 322 remitted from the phosphor containing layer 304 can be redirected to the bottom of the leaves of the plants 302. Thus, rather than losing the scattered red light, the article 300 assists in redirecting and reusing the reflected red light 322 towards the underside of the leaves of the plants 302 to promote further growth and spread of the plants 302.

The openings in articles in embodiments of the disclosure having a phosphor material adjacent or atop of a reflective material can have openings that occupy an area that can be less than the surface occupied by the footprint of the article. The openings in articles in some embodiments of the disclosure having a phosphor material adjacent or atop of a reflective material can have openings that occupy an area that can be 70 percent or less than the surface area occupied by the footprint of the article. In other embodiments the disclosure where the openings in the articles can control air flow into the growth chamber or can be advantageous for plant separation in the growth chamber, the area occupied by the openings in the articles can be between about 2% and about 70% of the surface area of the article.

The growth medium 306 can be a soilless growth medium such as but not limited to fabric, paper, coco coir, natural fibers, ceramic beads, clay pebbles, rockwool, and the like. The article 300 can include a substrate 305, a phosphor containing layer 304 on a top surface 309 of substrate 305, and an optional reflective layer (not shown) positioned below the phosphor containing layer 304. The optional reflective layer (not shown) can be positioned on the bottom surface 307 of the substrate 305. The top layer 304 of phosphor containing material can be a layer of phosphor, a composite material including phosphor particles, a light barrier layer incorporating phosphor and/or phosphor particles, or the like. The phosphor containing material layer 304 can be deposited or coated on a top surface 309 of substrate 305. The substrate 305 can be a polymeric film that can be transparent or opaque such as but not limited to mylar (e.g., biaxially-oriented polyethylene terephthalate), a rigid or semi-rigid stock sheet of polymers such as but not limited to acrylic or polycarbonate, or a structured material that can be corrugated and may be made from various cellulose based materials (e.g. cardboard), composites, or polymers (e.g. COROPLAST®). The transparent or opaque substrate 305 can have the phosphor containing material on surface 309 and a reflective material contacting the surface opposite 307.

In some embodiments, the substrate 305 may include embedded phosphor particles. The substrate surface 307 furthest from the light source may have a reflective material contacting the surface 307 of substrate 305. The article 300 may be positioned relative to a growth medium 306 and can be on a top surface of the growth medium 306. An optional support layer 308 for the growth medium can have openings 310 for roots and may be positioned below the growth medium 306. The incident light can include light directly striking 312 the developing plants 302 with roots 314 and light 312 directly striking germinating seed(s) 330 with root(s) 316. The germinating seed(s) may be positioned in openings 318 through the opposing surfaces 307, 309 of the article 300 including the phosphor layer 304. The incident light can also include light not directly striking 320 the developing plants 302 and germinating seed(s) 330. In embodiments of the disclosure, the phosphor containing layer 304 includes a fluorescent material and/or a phosphor material that can convert a portion of the light that is incident on surfaces of the article (e.g., surfaces that are not those of the developing plants and/or germinating seeds) to a longer wavelength light 322 of which a portion may be re-directed to the germinating seed(s) 330 and/or leaves of the developing plants 302. For example, shorter wavelength blue spectrum light incident on surfaces of the phosphor 304, which are not those of developing plants and/or germinating seeds, may be converted to a longer wavelength red spectrum light that may be redirected as longer wavelength light 322 to the developing plants and germinating seed(s).

FIG. 5 also illustrates that some incident light 320 that does not strike the plants can be reflected or reemitted back to the developing plants 302 at the same wavelength 320 or a longer wavelength 322. A phosphor containing material layer 304 of sufficient thickness to reduce light that contacts the growth medium 306 and defining a plurality of openings for seed(s), may be used to redirect the light not only down to the germinating seeds in the openings but redirect light up from the light barrier layer to the leaves of the developing plants. The disclosed phosphor containing layer 304 may be fabricated from a fluorescent or phosphor containing material, and may optionally include a light reflecting material, a light dispersing material, and any combination thereof.

In some embodiments of the disclosure, the substrate for the light remitting or phosphor containing layer, the light barrier layer, or other layers, may be fabricated from a class of plastic or composite material which may include embedded phosphor and/or fluorescent particles. In instances where the light does not pass through the openings and is not reflected from Fresnel reflections, the light may be absorbed into the body of the plastic layer(s). Once in the body of the plastic, the photon may encounter a phosphor and/or fluorescent particle. Typically, the longer the path of the photon within the plastic, the greater the chance of it striking one of these particles and improve the conversion efficiency of the article to longer wavelength light. When a photon strikes a phosphor or fluorescent particle, the particle may absorb the photon, then reemit a photon at a different, longer wavelength and in a random direction. For example, blue light absorbed by the body of the plastic can be redirected as red light from the phosphor to the leaves of developing plants to promote plant growth. In some embodiments of the disclosure, the substrate with openings therethrough for developing plants can contain embedded phosphor particles and may have a layer of phosphor containing material on a top surface.

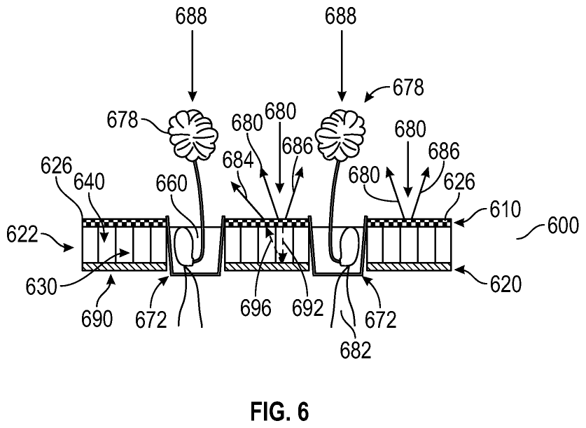

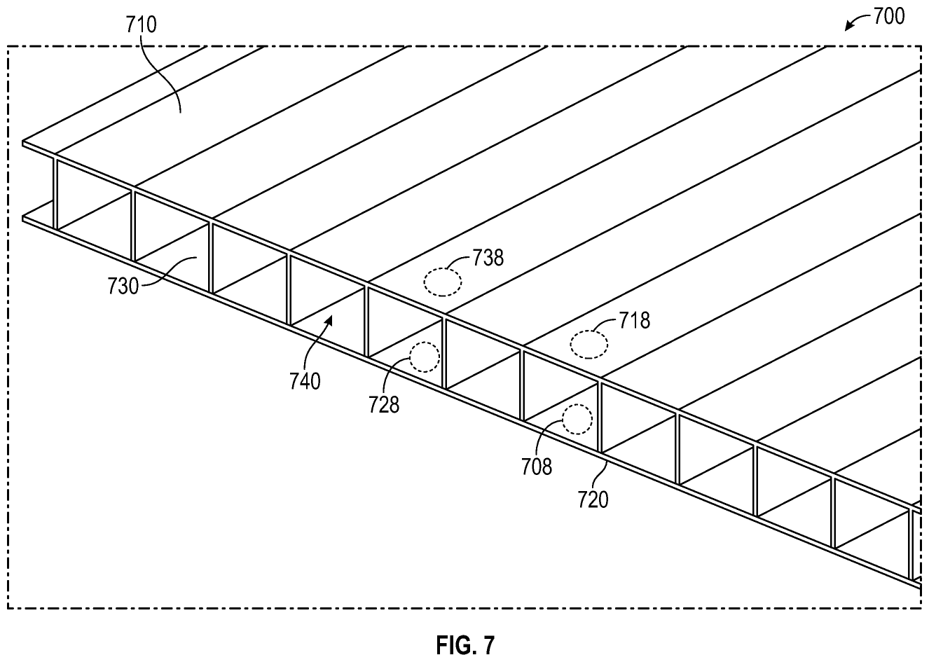

FIG. 6 is a diagrammatic, cross-sectional view of light incident on developing plants 678 and a phosphor containing layer 626 atop a substrate 622 with optional reflective layer 690 below the phosphor containing layer 626. The phosphor containing layer 626 can be positioned above a seed germination and plant development growth media 660 and at or above the grow plane of the plant in an embodiment of the present disclosure. Article 600 can include a substrate 622, a phosphor containing layer 626 on a top surface of the substrate 622, and a reflective layer 690 on a bottom surface of the substrate 622. The article 600 may be positioned relative to a growth medium 660. The growth medium 660 can be positioned in containers 672 which can be net pots or other suitable containers for developing plants 678. The containers 672 with growth medium 660 can be placed in openings formed in the substrate 622 between the substrate top surface 610 and substrate bottom surface 620; alternatively pieces or strips of article 600 can positioned around containers like 672 with plants 678. The plants 678 can have roots 682 positioned within and below the growth medium 660 and bottom of container 672. The incident light can include light directly striking 688 the developing plants 678 with roots 682 and light directly striking germinating seed(s) atop growth media in containers (not shown). The incident light can also include light not directly striking 680 the developing plants 678 and germinating seed(s). FIG. 6 also illustrates that some incident light 680 that does not strike the plants can be reflected or reemitted back to the developing plants 678 at the same wavelength 680 or a longer wavelength 686.

In embodiments of the disclosure, the article 600 may include a fluorescent material or phosphor material as a layer 626 on surface 610 that can convert a portion of the light that is incident on surfaces of the article (e.g., surfaces that are not those of the developing plants and/or germinating seeds) to a longer wavelength light 686 of which a portion may be redirected to the leaves of the developing plants 678. For example, shorter wavelength blue light incident on surfaces, which are not those of developing plants and/or germinating seeds, may be converted to a longer wavelength red light that may be redirected to the developing plants and germinating seed(s). FIG. 6 also illustrates that the article 600 including a phosphor containing layer 626 on a substrate 622 and reflective layer 690 below the phosphor containing layer 626 that can redirect and reflect light 696 from light 692 that may have initially passed through the phosphor layer 626 back into the phosphor containing layer 626 where it can be further red shifted and the resulting light 684 directed to the developing plants. In FIG. 6, the article with the phosphor containing layer 626 and one or more openings therethrough with a reflective layer 690 can cover spaces between developing plants positioned in containers 672 with a plant growth medium 660.

The article 600 can include a substrate 622 in FIG. 6 that can have a top surface 610, a bottom surface 620, and stand-offs 630 between the top and bottom layer that physically separate the two layers. Openings 640 can be formed between stand-offs 630 and top surface 610 and bottom surface 620. These openings 640 can extent the length of the substrate 622 and can improve removal of heat generated by the phosphor containing layer 626 and facilitate temperature control in the vicinity of the plants. For example, the openings 640 can allow for air movement through the thickness of the substrate 622, acting as a heat sink or heat dissipating structure to reduce heat generated during the blue to red light conversion provided by the phosphor containing layer 626.

FIG. 7 is a cross-sectional image of an embodiment of a substrate 700, similar to substrate 622, that can have a layer of phosphor containing material atop an upper surface 710. The substrate 700 can have a corrugated structure. For example, the substrate 700 in FIG. 7 can have a top surface 710, a bottom surface 720, and stand-offs 730 between the top surface 710 and bottom surface 720 that physically separate the two surfaces or layers. The stand-offs 730 form openings 740 that extend the length or thickness of the substrate 700. COROPLAST® and corrugated cardboard are non-limiting examples of corrugated substrates that can be made from various polymeric materials and used in embodiments of the disclosure. Openings can be formed in the substrate 700 between the bottom and top surfaces. For example, openings 718 and 738 can be formed through the upper surface 710 and corresponding openings 708 and 728 can be formed through the lower bottom surface 720.

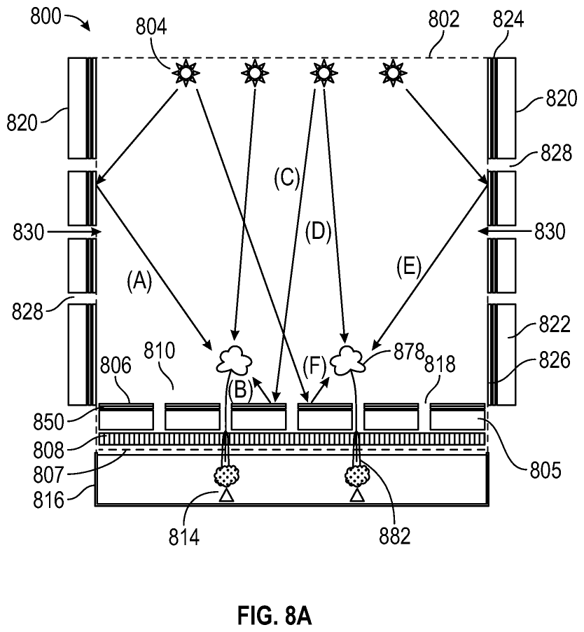

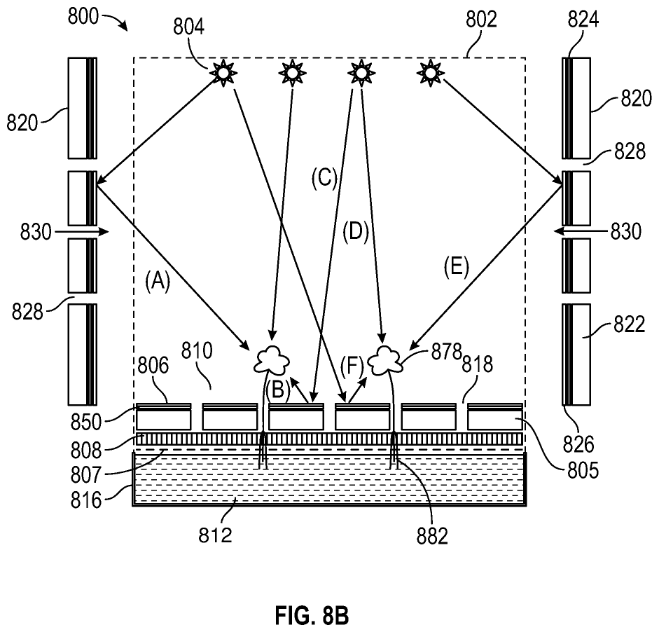

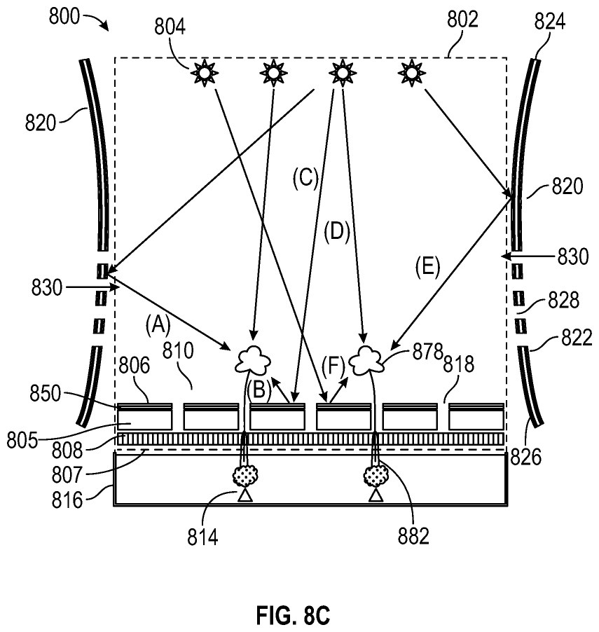

FIGS. 8A-C illustrate side views of embodiments of plant development system 800 that includes a growth chamber 802. The growth chamber can encompass the plant envelope and grow media 808. The growth chamber 802 can include lighting 804, a nutrient supply 816 unit or container that can provide nutrients by nozzles 814 (FIGS. 8A and 8C) or as a bath 812 (FIG. 8B) to roots 882 of plants 878. The growth chamber can further include a grow media 808 positioned on a support 807 that the plant roots 882 can protrude through. The growth chamber 802 can include one or more articles such as 810 and 820, the article comprising a phosphor material 806 or 826, the article can have one or more openings 818 or 828 extending through a thickness of the phosphor material. The articles such as 810 and 820 can be positioned in relation to the plant development system and/or growth chamber. Blue spectrum containing light from light sources 804 can directly contact the plants 878 (see labels C and D to the left of the rays). A portion of blue spectrum containing light can be wavelength shifted and redirected from 810 and/or 820 (see labels A, E, B, F (note: label positioned to the left of illustrative light ray)) in the growth chamber 802 onto surfaces of developing plants 878. FIG. 8A illustrates an embodiment of a growth chamber 802 (dashed line) where the one or more articles 810 and 820 are positioned in relation to the growth chamber such that one or more of the articles can be within or adjacent the growth chamber 802; FIG. 8B illustrates an embodiment of a plant development system 800 where the growth chamber includes the one or more articles 810 and 820 that can be positioned in relation to the plant development system 800 outside of the growth chamber 802 and outside of the envelope of the plants 878 and grow media 808; FIG. 8C illustrates and embodiment of a plant development system 800 where the one or more articles 810 and 820 can be positioned in relation to the growth chamber 802 outside of the growth chamber 802 and the articles such as 810 or 820 can have a non-planar configuration.

The openings, for example opening 818 in article 810, can accommodate one or more developing plants 878. Openings 828 in article 820 can permit the flow of air 830 into or out of the growth chamber 802. Articles such as 810 and 820 can include a phosphor containing material or phosphor containing layer 806, 826, a reflective layer 850, 824 between the phosphor containing material or phosphor containing layer and an optional substrate 805, 822. One or more articles 810 and 820 can be positioned in relation to the growth chamber 802 (dashed line).

In embodiments of the articles of the disclosure, the one or more openings through the phosphor containing material, the reflective material, and optionally the substrate can be spaced apart. Light incident on an opening such as 818, 828, or 718 and 708, may pass completely through the opening or can strike the inner wall of the opening and may be wavelength shifted and redirected but at substantially less intensity than light directly incident or striking the outward facing phosphor material surface. The amount of light wavelength shifted and redirected under the same lighting conditions by an article without openings is greater than amount of light that is wavelength shifted and redirected by the same sized article but having the one or more openings therethrough.

Articles of the disclosure can include the phosphor material, a reflective material adjacent to the phosphor material, and optionally a substrate adjacent to the reflective material and separated from the phosphor material. In some embodiments the reflective layer can be a surface of the substrate. In some embodiments the reflective material 824 may be absent and the substrate 822 outer surface, which can be reflective or partially reflective to the incident light and/or wavelength shifted light from the phosphor material, can be adjacent to the phosphor material 826. For example, the substrate material 822 can be partially reflective and positioned adjacent to the phosphor layer 826. In embodiments of the disclosure, the reflective material or reflective surface of a substrate can reflect the incident light and/or the wavelength shifted light from the phosphor layer. In other embodiments of the disclosure, the reflective material or reflective surface of a substrate can have a reflectivity of less than 90 percent for the incident light and/or the wavelength shifted light from the phosphor layer.

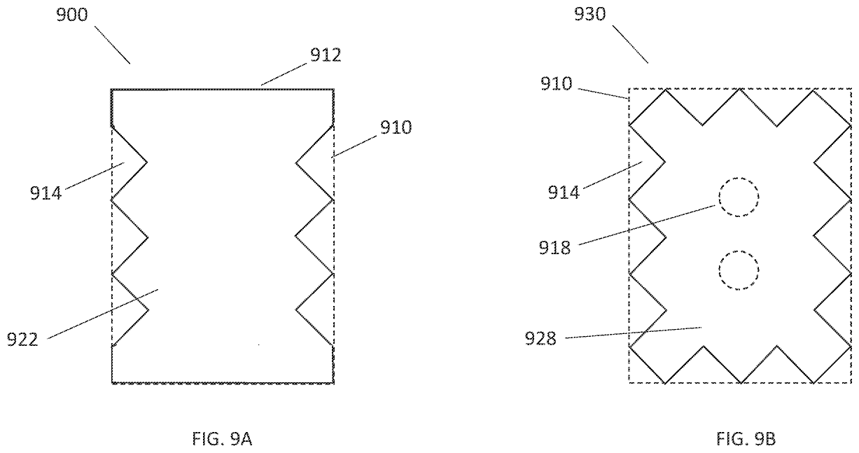

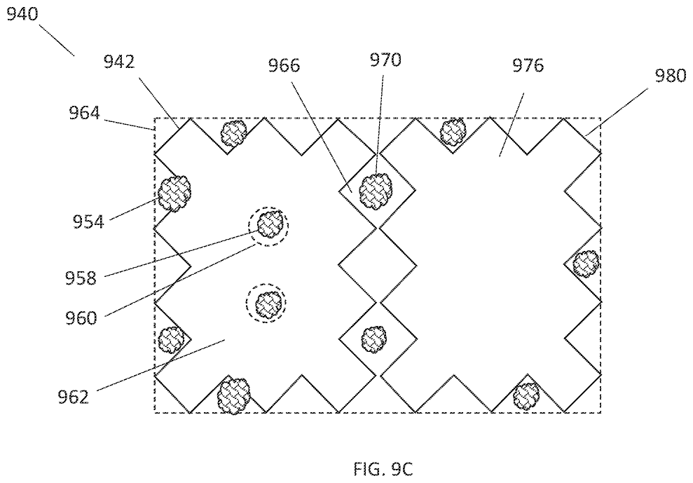

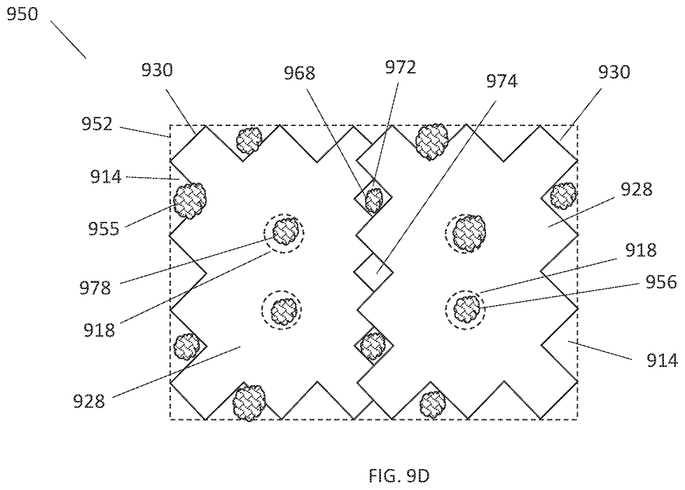

FIGS. 9A-D illustrates a top down views of embodiments of the articles of the disclosure that can redirect at least a portion of light from a plant development system and/or a growth chamber as longer wavelength shifted light onto surfaces of developing plants in the plant development system and/or growth chamber.

FIG. 9A illustrates an article 900 that includes a phosphor material as a top layer, a reflective material below the phosphor material, and an optional substrate below the phosphor material. The article can have various shapes for positioning about developing plants in a plant growth system. The article 900 can have straight edges 912, and other edge profiles 914 including but not limited to curved edges, saw tooth, scallops, or combinations of these and other edge profiles. The article 900 can have a footprint 910 depicted by dashed line rectangle. In some embodiments the edge profile can form unoccupied areas such as 914 that can accommodate the shoot of a plant. The article can have closed areas 922 without openings these closed areas can redirect light interacting with the phosphor layer back to surfaces of plants.

FIG. 9B illustrates an article 930 that includes a phosphor material as a top layer, a reflective material below the phosphor material, and an optional substrate below the phosphor layer. The article 930 can have various shapes for positioning near developing plants in a plant growth system. The article 930 can have straight edges, edge profiles 914 including but not limited to curved edges, saw tooth, scallops, or combinations of these and other edge profiles. The article 930 can have a footprint 910 depicted by dashed line rectangle. In some embodiments the edge profile can form areas such as 914 that can accommodate the shoot of a plant. The article can further have one or more optional open areas shown as one or more openings 918 through the phosphor material, optional substrate, and reflective material that allow for developing plants or the passage of air. Article 930 can have closed areas 928 without openings that can redirect light interacting with the phosphor layer back to surfaces of plants.

FIG. 9C illustrates an article 940 formed by tiling or combining one or more articles such as 942 with openings 960 (left) with an article such as 980 without openings (right). The combination of articles 942 and 980 can be used in a plant development system or a growth chamber. The articles 942 and 980 are illustrated as being substantially adjacent and can be touching. Article 980 has a closed area 976 and saw tooth edge features. FIG. 9C. further illustrates plants such as 970 positioned in open areas 966 formed by edge profiles 914 from adjacent articles like 942 and 980. Plants such as 958 can be positioned in openings like 960 formed in closed areas 962 of the article 942. Article 942 can be positioned such that edge profile features can encompass shoot portions of plants like 954. The area or footprint occupied by the article 940 can be illustrated by the dashed boarder outline 964.

FIG. 9D illustrates an article 950 formed by tiling or combining one or more articles such as 930 with openings 918 (e.g. FIG. 9B). The combination of articles 930 can be used in a plant development system or a growth chamber to redirect wavelength shifted light from the phosphor layer of the articles 930 to developing plants. The shoots of plants such as 956 and 978 can protrude through openings such as 918. The articles 930 are shown as partially overlapping and can form openings like 972 and 974 where the edge profile features 914 overlap. The size of the openings 972 and 974 can vary with the amount of overlap of the articles 930. Opening 972 is an example of an opening formed by edge profile features 914 that can surround the shoot portion of a plant like 968. Articles 930 can each have a closed area 928 and edge profile features 914. FIG. 9D. further illustrates plants such as 955 positioned in open areas formed by notches 914 on the outer perimeter of article 950. The area or footprint occupied by the article 950 can be illustrated by the dashed outline 952.

Embodiments of the article can be a flexible film having a phosphor containing material atop a reflective material. The flexible article can be positioned between plants or positioned relative to the growth chamber along the bottom and/or the sides of the chamber. The flexible film can have a flat configuration in some embodiments. In other embodiments the flexible film can have a curved, pleated, a wrapped, or a random landscape. For example, as illustrated in FIG. 8C, the articles 820 can have a convex configuration in relation to the plants and articles can face one another across the growth chamber 802 (dashed line). In some embodiments the article 810 can have a convex configuration facing the plants to enhance focus of wavelength shifted light toward the plants in the growth chamber. In some embodiments where the article is a film, the film can be positioned relative to the plants by wrapping the flexible film about the shoot portion of the plants or by using the flexible article as a skirt about the shoot portion of the plants. In some other embodiments the article are self-supporting and pieces of the article can be tiled around plants and plant shoots in the growth chamber or can be positioned along the sides of the growth chamber.

In articles having one or more openings and/or edge features, the openings and/or edge features in the article can be less than the total area of the article. In some articles having one or more openings and/or edge features, the openings and/or edge features in the article can be 70 percent (%) less than the total area of the article. In other embodiments having one or more openings and/or edge features, the openings and/or edge features in the article can be between 2% and 70% of the total area of the article. Un-opened portions of the article can reduce algal formation in nutrient solutions and surfaces in contact with the nutrient solutions in aeroponic and hydroponic growth chambers by blocking light from reaching nutrient drip pans and nozzles or nutrient baths.

Reflective material or surface of substrate can reflect incident light and/or wavelength shifted light to surfaces of plants in the growth chamber.

The following clauses define particular aspects and embodiments of the disclosure.

Clause 1. An article 810, 820, 930 for use in a growth chamber 802, said article comprising: a phosphor material 806, 826 said article has one or more openings 818, 828, 914, 918 extending through a thickness of the phosphor material, the article positioned in relation to the growth chamber redirects at least a portion of light to grow developing plants in the growth chamber as longer wavelength shifted light onto surfaces of developing plants 878 in the growth chamber.

Clause 2. The article of clause 1, further comprising a reflective material 850, 824, said reflective material adjacent to the phosphor material 806, 826 and the one or more openings 818, 828 extend through a thickness of the phosphor material and through a thickness of the reflective material.

Clause 3. The article of clause 2 wherein the reflective material is a substrate 700 that comprises a reflective surface 710.

Clause 4. The article of clause 2 further comprising a substrate 805, 822 said substrate is adjacent to the reflective material 850, 824 and the reflective material is between the phosphor material 806, 826 and the substrate, the one or more openings 818, 828 extend through the thickness of the phosphor material, through the thickness of the reflective material, and through a thickness of the substrate.

Clause 5. The article as in any one of clauses 1-4, wherein the longer wavelength shifted light comprises red spectrum containing light.

Clause 6. The article as in any one of clauses 1 to 3, wherein the openings 818, 828, 914, 918 reduce the amount of longer wavelength shifted light redirected to the developing plants in the growth chamber compared to an article without the openings.

Clause 7. The article as in any one of clauses 1-6, wherein the article is flexible film.

Clause 8. A growth chamber 802 comprising the article as in any one of clauses 1-7, wherein the article is position at or above the grow plane of the developing plants in the growth chamber.

Clause 9. The growth chamber 802 of clause 8 comprising one or more articles 820 as in any one of clauses 1-7 in a facing relationship in the growth chamber openings.

Clause 10. An article for use in a growth chamber in which the article is illuminated with light for growing plants, said light for growing plants comprises light in a wavelength range from 400 to 500 nanometers, the article comprising: a phosphor material 806, 826 configured to absorb a portion of the light for growing the plants and emits longer wavelength shifted light; and, a reflective material 850, 824 adjacent to the phosphor material that reflects the longer wavelength shifted light and the light for growing the plants.

Clause 11. The article of clause 10 said phosphor material 806 has one or more openings 918 or one or more edge notches 914 through a thickness of the phosphor material; and a reflective material 850, 824 adjacent to the phosphor material that reflects the longer wavelength shifted light and the light for growing the plants, the reflective material has one or more openings or one or more edge notches through a thickness of the reflective material.

Clause 12. The article of clause 11 wherein the article comprises openings 818, 828, 918 and edge notches 914.

Clause 13. The article of clause 11 wherein the article is absent edge notches.

Clause 14. The article as in any of clauses 10-13 further comprising a substrate 805, 822, the reflective material between the phosphor materials and the substrate.

Clause 15. The article as in any one of clauses 10-13 wherein the reflective material is a substrate, and the substrate has a reflective surface.

Clause 16. The article as in any one of clauses 10-15 wherein the article is a flexible material 820.

Clause 17. The article as in any one of clauses 14-15 wherein the substrate is a corrugated material 700.

Clause 18. The article as in any one of clauses 10-17 wherein the article can be tiled or overlapped with at least a second article to form openings 972, 974.

Clause 19. The article as in any one clauses 10-17 wherein the total area of the openings 918 and/or notches 914 comprising the article is 70 percent or less of the total area of the article.

Clause 20. A growth chamber 802 comprising the article 810 as in any one of clauses 10-19

Clause 21. The growth chamber 802 of clause 20 comprising one or more plants 878, wherein surfaces of the plants are positioned above surfaces of the articles 810 as in any one of clauses 10-17.

Clause 22. A method of growing plants in a growth chamber 802 comprising: providing light comprising a blue spectrum component to developing plants 878 in a growth chamber comprising an article as in any one of clauses 10-17 positioned in a relation to the growth chamber, redirecting at least a portion of the light comprising the blue spectrum component as longer wavelength shifted light from the article onto surfaces of developing plants in the growth chamber.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An article that supports germinating seeds and growing plants, the article including:
a phosphor containing layer disposed atop a substrate, the substrate including a plurality of openings extending through a thickness of the phosphor containing layer, each opening of the plurality of openings capable of accommodating passage therethrough of the developing plants;
said phosphor containing layer or a composite with phosphor particles configured to convert light incident on the reflective layer into red spectrum light, and redirect the red light to the developing plants.

2. The article of claim 1, wherein the substrate has a corrugated structure.

3. The article of claim 1, wherein the phosphor particles are mulched phosphor chips or micron sized or smaller phosphor particles.

4. The article of claim 1, wherein the phosphor containing layer is disposed at a growth plane of the developing plants.

5. The article of claim 1, further comprising a reflective layer positioned below the phosphor containing layer.

6. A seed germination and plant development system, comprising:
a growth chamber;
a light source disposed within the growth chamber; and
an article disposed within the growth chamber and under the light source, the article including:
a growth medium capable of accommodating one or more seeds, and supporting seed germination and penetration of roots from developing plants therethrough; and
a substrate comprising a phosphor containing layer on a top surface of the substrate and openings for developing plants therethrough, the substrate disposed over the growth medium,
wherein the phosphor containing layer atop the substrate is configured to convert light incident on the reflective layer from the light source into red spectrum light, and redirect the red light to the developing plants.

7. The system of claim 6, wherein the reflective layer is disposed at a growth plane of the developing plants.

8. The system of claim 6, further comprising a reflective layer positioned below the phosphor containing layer.

9. The system of claim 6, wherein the substrate has a corrugated structure.

10. An article for use in a growth chamber, said article comprising: a phosphor material, said article has one or more openings extending through a thickness of the phosphor material, the article positioned in relation to the growth chamber redirects at least a portion of light to grow developing plants in the growth chamber as longer wavelength shifted light onto surfaces of developing plants in the growth chamber.

11. The article of claim 10, further comprising a reflective material said reflective material adjacent to the phosphor material and the one or more openings extend through a thickness of the phosphor material and through a thickness of the reflective material.

12. The article of claim 10, wherein the reflective material is a substrate that comprises a reflective surface.

13. The article of claim 11, further comprising a substrate said substrate is adjacent to the reflective material and the reflective material is between the phosphor material and the substrate, the one or more openings extend through the thickness of the phosphor material, through the thickness of the reflective material, and through a thickness of the substrate.

14. The article of claim 10, wherein the longer wavelength shifted light comprises red spectrum containing light.

15. The article of claim 10, wherein the openings reduce the amount of longer wavelength shifted light redirected to the developing plants in the growth chamber compared to an article without the openings.

16. The article of claim 10, wherein the article is flexible film.

17. A growth chamber comprising the article of claim 10, wherein the article is positioned at or above the grow plane of the developing plants in the growth chamber.

18. The growth chamber of claim 17, comprising one or more of said articles in a facing relationship in the growth chamber openings.

19. An article for use in a growth chamber in which the article is illuminated with light for growing plants, said light for growing plants comprises light in a wavelength range from 400 to 500 nanometers, the article comprising: a phosphor material configured to absorb a portion of the light for growing the plants and emits longer wavelength shifted light; and, a reflective material adjacent to the phosphor material that reflects the longer wavelength shifted light and the light for growing the plants.

20. The article of claim 19, said phosphor material has one or more openings or one or more edge notches through a thickness of the phosphor material; and a reflective material adjacent to the phosphor material that reflects the longer wavelength shifted light and the light for growing the plants, the reflective material has one or more openings or one or more edge notches through a thickness of the reflective material.

21. The article of claim 20, wherein the article comprises openings and edge notches.

22. The article of claim 20, wherein the article is absent edge notches.

23. The article of claim 19, further comprising a substrate, the reflective material positioned between the phosphor materials and the substrate.

24. The article of claim 19, wherein the reflective material is a substrate, and the substrate has a reflective surface.

25. The article of claim 19, wherein the article is a flexible material.

26. The article of claim 23, wherein the substrate is a corrugated material.

27. The article of claim 19, wherein the article is tiled or overlapped with at least a second article to form openings.

28. The article of claim 19, wherein the total area of the openings and/or notches comprising the article is 70 percent or less of the total area of the article.

29. A growth chamber comprising the article of claim 19.

30. The growth chamber of claim 29, comprising one or more plants, wherein surfaces of the plants are positioned above surfaces of one or more of said articles.

31. A method of growing plants in a growth chamber comprising: providing light comprising a blue spectrum component to developing plants in a growth chamber comprising an article of claim 19 positioned in a relation to the growth chamber, redirecting at least a portion of the light comprising the blue spectrum component as longer wavelength shifted light from the article onto surfaces of developing plants in the growth chamber.
